(19) United States
(12) Patent Application Publication
(10) Pub. No.: US 2002/0087325 A1
(43) Pub. Date: Jul. 4, 2002

(54) Dialogue application computer platform

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: John V. Biernacki, Esq., Jones, Day, Reavis & Pogue, North Point, 901 Lakeside Avenue, Cleveland, OH, 44114, US

(21) Appl. No.: 09/863,575

(22) Filed: May 23, 2001

Related U.S. Application Data
(60) Provisional application No. 60/258,911, filed on Dec. 29, 2000.

(51) Int. Cl. G10L 21/00; G10L 11/00

(52) U.S. Cl. 704/270.1

(57) ABSTRACT

A computer-implemented system and method for processing speech input from a user. A call management unit receives a call from the user and through which the speech input is provided by the user. A speech management unit recognizes the user speech input through language recognition models. The language recognition models contains word recognition probability data derived from word usage on Internet web pages. A service management unit handles e-commerce requests contained in the user speech input. A web data management unit connected to an Internet network processes Internet web pages in order to generate the language recognition models for the speech management unit and to generate a summary of the Internet web pages. The generated summary is voiced to the user in order to service the user request.

### RELATED APPLICATION

This application claims priority to U.S. provisional application Serial No. 60/258,911 entitled “Voice Portal Management System and Method” filed Dec. 29, 2000. By this reference, the full disclosure, including the drawings, of U.S. provisional application Ser. No. 60/258,911 are incorporated herein.

### FIELD OF THE INVENTION

The present invention relates generally to computer speech processing systems and more particularly, to computer systems that recognize and process spoken requests.

### BACKGROUND AND SUMMARY OF THE INVENTION

Speech recognition systems are increasingly being used in telephony computer service applications because they are a more natural way for information to be acquired from people. For example, speech recognition systems are used in telephony applications where a user through a communication device requests that a service be performed. The user may be requesting weather information to plan a trip to Chicago. Accordingly, the user may ask what is the temperature expected to be in Chicago on Monday.

The present invention is directed to a suite of intelligent voice recognition, web searching, Internet data mining and Internet searching technologies that efficiently and effectively services such spoken requests. More generally, the present invention provides web data retrieval and commercial transaction services over the Internet via voice. Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram that depicts the computer and software-implemented components used to recognize and process user speech input;

FIG. 2 is a block diagram that depicts the present invention's call management unit;

FIG. 3 is a block diagram that depicts the present invention's speech management unit;

FIG. 4 is a block diagram that depicts the interactions between the speech server resource control unit and the automatic speech recognition servers;

FIG. 5A is a block diagram that depicts the present invention's resource allocation approach for speech recognition;

FIG. 5B is a block diagram that depicts the present invention's speech recognition approach;

FIG. 6 is a block diagram that depicts the present invention's service management unit;

FIG. 7 is a block diagram that depicts the interactions i involving the service management unit;

FIG. 8 is a block diagram that depicts the present invention's e-commerce transaction server;

FIG. 9 is a block diagram that depicts the present invention's customization management unit;

FIG. 10 is a block diagram that depicts the present invention's web data management unit;

FIG. 11 is a block diagram that depicts the present invention's web content cache server;

FIG. 12 is a block diagram that depicts the present invention's web link cache server;

FIG. 13 is a block diagram that depicts the present invention's web site information tree approach;

FIG. 14 is a block diagram that depicts the present invention's structure of the web content summary engine;

FIG. 15 is a block diagram that depicts the present invention's personal profiles database management unit;

FIG. 16 is a block diagram that depicts the present invention's system security;

FIG. 17 is a block diagram that depicts the present invention's speech processing network architecture;

FIG. 18 is a block diagram that depicts an exemplary service center approach that uses the system of present invention;

FIG. 19 is a block diagram that depicts an exemplary wide area service center approach that uses the system of the present invention; and

FIG. 20 is a block diagram that depicts an exemplary wide area and local area service centers approach that uses the system of the present invention.

### DETAILED DESCRIPTION OF THE PREFERRED EMBODIMENT

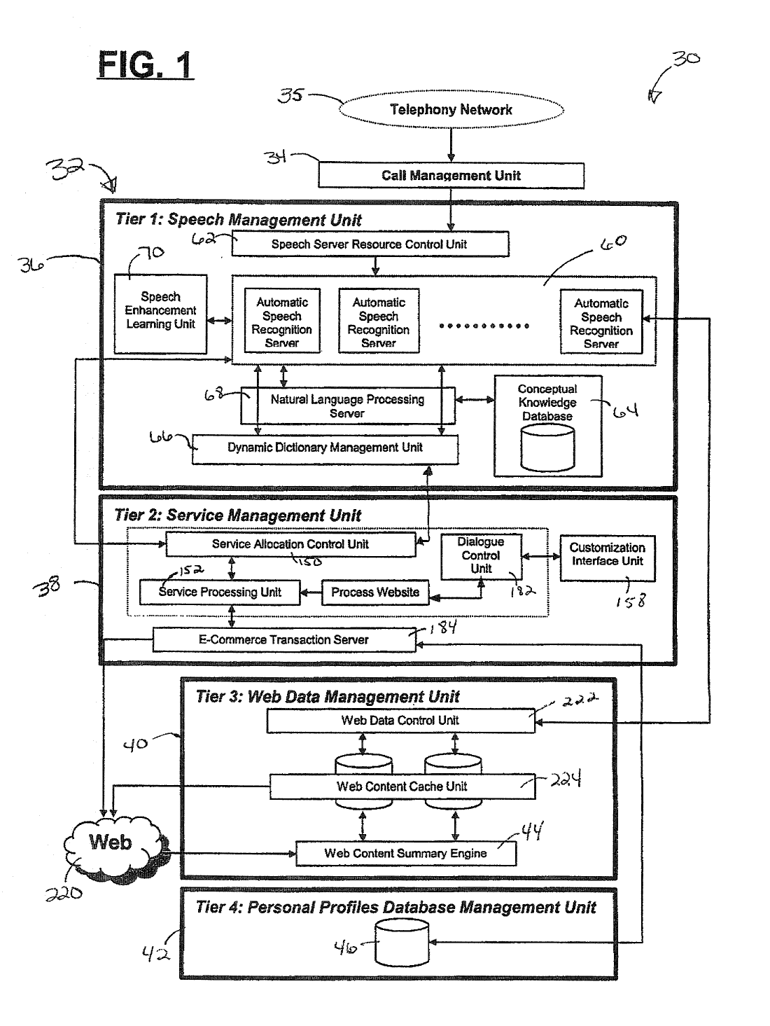

FIG. 1 depicts at 30 a voice portal management system. The voice portal management system 30 architecture uses four tiers 32 linked to a call management unit 34 which in turn receives input from a telephony network 35. The four tiers and its interfacing unit are: call management unit 34; speech management unit 36 (Tier 1); service management unit 38 (Tier 2); web data management unit 40 (Tier 3); and database/personal profiles management unit 42 (Tier 4). An overview description of the voice portal management system 30 follows.

Call Management Unit 34

The call management unit 34 is a multi-call telephone control system that manages inbound calls and routes telephone signals to the voice portal management system 30. Its functions include: signal processing; noise cancellation; data format manipulation; automatic user registration; call transfer and holding; and voice mail.

The call management unit 34 is fully scalable and can accommodate any number of simultaneous calls.

Speech Management Unit 36

The speech management unit 36 represents Tier 1 of the system. It provides continuous speech recognition and understanding. It uses: speech acoustic models, grammar models and pronunciation dictionaries to transform speech signals to text and semantic knowledge to convert text into meaningful instructions that can be understood by the computer systems. The speech management unit 36 is language, platform and application independent. It accommodates many languages. It also adapts on demand to alternative domains and applications by switching speech recognition dictionaries and grammars.

Service Management Unit 38

The service management unit 38 is Tier 2 of the system 30. It provides conversation models for managing human-to-computer interactions. Messages derived from those interactions drive system actions including feedback to the user.

The service management unit 38 also provides development tools for customizing user interaction. These tools ensure relevant translation of Hypertext Markup Language (HTML) web pages to voice.

Web Data Management Unit 40

The web data management unit 40 is Tier 3. It is a data mining and content discovery system that returns data from the Internet on demand. It responds to user requests by generating relevant summaries of HTML content. A web summary engine 44 forms part of this tier.

The web data management unit 40 maintains data caches for storing frequently accessed information, including web content and web page links, thereby keeping response times to a minimum.

Personal Profiles Database Management Unit 42

Tier 4 is the personal profiles database management unit 42. It is a group of servers and high-security databases 46 that provide a supporting layer for other tiers. The personal profiles database management unit 42 and servers in the speech management unit 36 share the SSL encryption standards.

The following describes each component in greater detail.

### Call Management Unit

The call management unit 34 accepts Ti connections from the telephony network 35. It is responsible for incoming call management including call pick up, call release, user authentication, voice recording and message playback. It also maintains records of call duration.

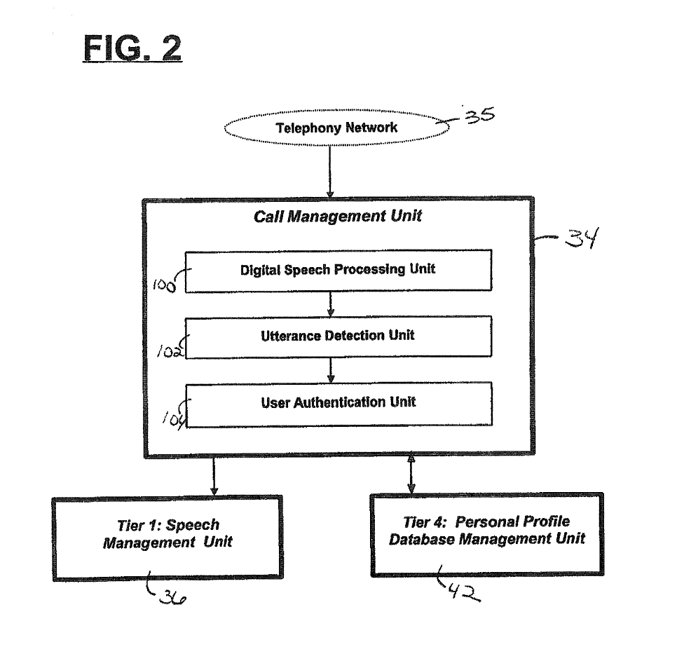

The call management unit 34 communicates directly with the speech management unit 36 of Tier 1 by sending utterances to the speech recognition servers. It also connects to Tier 4, the personal profile database management unit 46. The unit includes several interactive components as shown in FIG. 2.

Digital Speech Processing Unit

With reference to FIG. 2, after a pre-determined number of rings, the call management unit 34 automatically picks up an incoming call. The digital speech processing unit 100 utilizes software digital signal processing echo cancellation to reduce line echo caused by feedback. It also provides background noise cancellation to enhance voice quality in wireless or otherwise noisy environments. An automatic gain control noise cancellation unit dynamically controls noise energy components. The noise cancellation system is described in applicant's United States application entitled “Computer-Implemented Noise Normalization Method and System” (identified by applicant's identifier 225133-600-017 and filed on May 23, 2001) which is hereby incorporated by reference (including any and all drawings).

Utterance Detection Unit 102

The utterance detection unit 102 detects utterances from the caller. A built-in energy detector measures the voice energy in a sliding time window of about 20 ms. When the detected energy rises above a predetermined threshold, the utterance detection 102 unit starts to record the utterance, stopping once the energy level falls below the threshold. Utterance detection unit 102 includes a barge-in capability, allowing the user to interrupt a message at any time.

User Authentication Unit 104

The user authentication unit 104 provides system integrity. It provides the option of authenticating each user on entry to the system. User authentication unit 104 prompts the user for password or personal identification number (PIN). By default the system expects the response from the telephone keypad. However, the user authentication unit 104 has the ability to accommodate voice signature technology, thus providing the opportunity to crosscheck the PIN with the user's voice print or signature.

### Speech Management Unit

With reference back to FIG. 1, the speech management unit 36 represents Tier 1of the voice portal management system 30. It accepts natural language input from the call management unit 34 and sends appropriate instructions to Tier 2 38. It includes the following components: speech server resource control unit 62; automatic speech recognition server 60; conceptual knowledge database 64; dynamic dictionary management unit 66; natural language processing server 68; and speech enhancement learning unit 70.

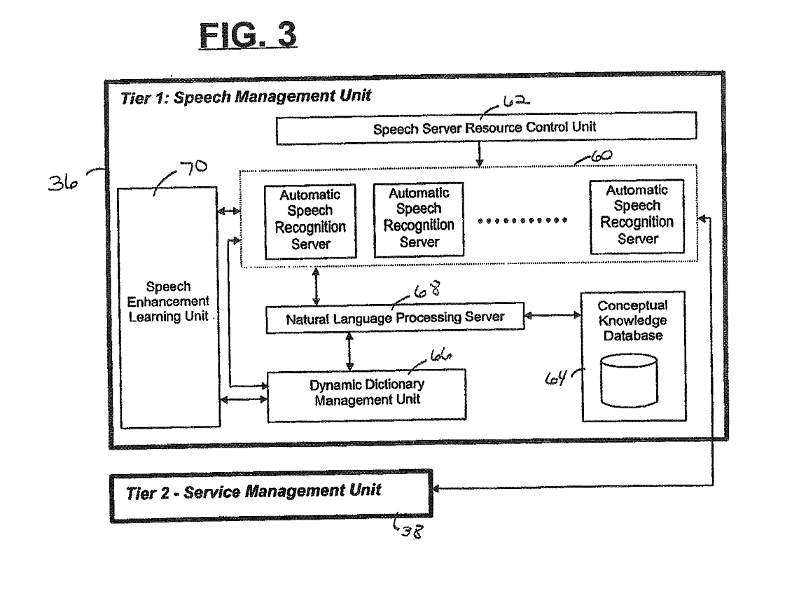

FIG. 3 shows the elements that comprise the speech management unit 36 along with interactions among the component parts.

Speech Server Resource Control Unit 62

With reference to FIG. 3, the speech server resource control unit 62 is responsible for load balancing and resource optimization across any number of automatic speech recognition servers 60. It directly controls and allocates idle processes by queuing incoming voice input and detecting idle times within each automatic speech recognition servers 60. Where an input utterance requires multiple speech decoding processes, speech server resource control unit 62 predicts the required number. It then initiates and manages the activities required to convert the speech to text.

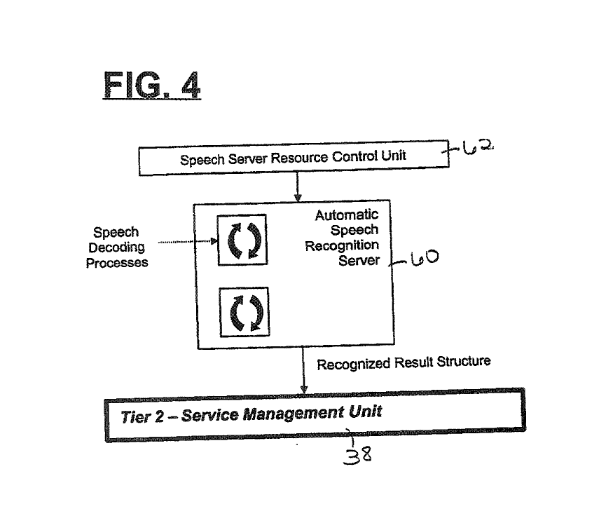

The speech server resource control unit 62 also manages the interaction between the speech management unit 36 (Tier 1) and the service management unit 38 (Tier 2). As text-based information is derived from the automatic speech recognition server 60, speech server resource control unit 62 coordinates and directs the output to the service management unit 38 as shown by FIG. 4.

Automatic Speech Recognition Server 60

With reference to FIG. 4, the automatic speech recognition servers 60 run simultaneous speech decoding and speech understanding engines. Automatic speech recognition servers 60 allocates multiple language models dynamically: for example, with the web site Amazon.com, it loads subject, title and author dictionaries ready to be applied to the decoding of any user speech input. A queue unit coordinates multiple utterances from the voice channels so that as soon as a decoder is free the next utterance is dispatched. Automatic speech recognition servers 60 applies a Hidden Markov Model to the raw speech output. It uses the speech recognition output as the observation sequence and the keyword pairs in the concordance models as the underlying sequence. The emission probabilities are obtained by calculating the pronunciation similarities between the observation sequence and the underlying sequence. The most likely underlying sequence for a certain domain and input sequence (i.e., the output sequence of the speech recognizer) is returned as the best estimate of the true conceptual (keyword) sequence of the input utterance. This is then sent to the natural language processing server 68 for further processing.

The primary function of the automatic speech recognition servers 60 is to determine the correct keyword sequence, an understanding that is essential if the system is to respond correctly to user input. It focuses on the capture of verbs, nouns, adjectives and pronouns, the elements that carry the most important information in an input utterance. Within the automatic speech recognition servers 60, each speech decoder process works in batch mode (with loaded utterance files) and live mode. This guarantees that the whole utterance, not just a partial utterance, is subject to multiple scanning.

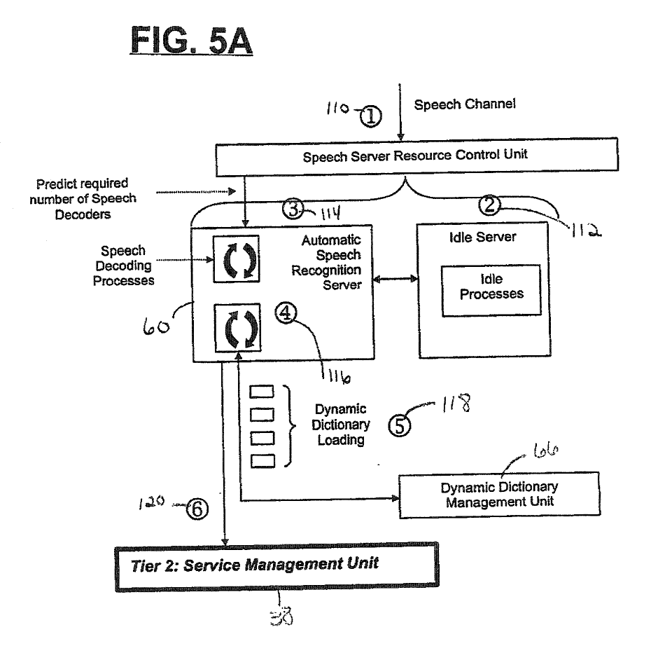

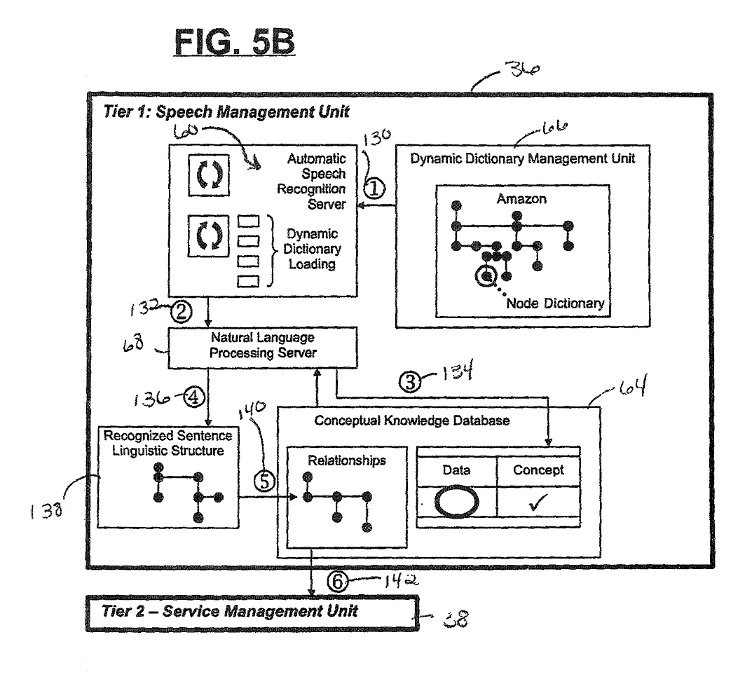

With reference to FIG. 5A, the automatic speech recognition servers 60 uses a dynamic dictionary creation technology to assemble multiple language models in real time. The dynamic dictionary creation technology is described in application entitled “Computer-Implemented Dynamic Language Model Generation Method And System” (identified by applicant's identifier 225133-600-009 and filed on May 23, 2001) which is hereby incorporated by reference (including any and all drawings). It optimizes accuracy and resource allocation by scaling the size of the dynamic dictionaries based on request and service. The process flow is as follows for resource allocation for speech recognition:

1. Accepts utterances from voice channels (as shown at 110).

2. Predicts number of speech decoder processes required (as shown at 112).

3. Allocates idle servers (as shown at 114).

4. Allocates idle processes (as shown at 116).

5. Manages processing of utterances (as shown at 118).

6. Dispatches processed data to Tier 2 (as shown at 120).

Natural Language Processing Server 68

With reference back to FIG. 1, the natural language processing server 68 transforms natural language input into a meaningful service request for the service management unit. By connecting to the automatic speech recognition server 60, it receives text output directly from the speech decoding process.

This server derives syntactic, semantic and control-specific conceptual patterns from the raw speech recognition results. It immediately connects to the conceptual knowledge database unit 64, to fetch knowledge of syntactic linkages between words.

Data from the natural language processing server 68 becomes a data structure with a conceptual relationship among the words. The structure is then sent to the service management unit 38 (Tier 2), as an instruction to get responses from particular services.

Conceptual Knowledge Database Unit 64

The conceptual knowledge database unit 64 supports the natural language processing servers 68. It provides a knowledge base of conceptual relationships among words, thus providing a framework for understanding natural language. Conceptual knowledge database unit 64 also supplies knowledge of semantic relations between words, or clusters of words, that bear concepts. For example, “programming in Java” has the semantic relation:

[Programming-Action]−<means>−[Programming-Language(Java)];

The conceptual knowledge database unit 64 receives all recognized words from the automatic speech recognition server 60. Its function is to eliminate incorrect words by applying the semantic and logical rules contained in the database to all recognized words. It assigns weights based on the conceptual relationships of the words and derives the “best fit” result.

The conceptual knowledge database unit 64 also provides a semantic relationship structure for the natural language processing server 68. It provides the meaning that the natural language processing server 68 requires to launch instructions to the service management unit 38.

The conceptual knowledge database unit 64 statistical model is based on conditional concordance algorithms within a knowledge-based lexicon. These models calculate conditional probabilities of conceptual keywords co-occurrences in domain-specific utterances, using a large text corpus together with a conceptual lexicon. The lexicon describes domain, category and signal information of words which are subsequently used as classifiers for estimating most likely conceptual sequences.

Dynamic Dictionary Management Unit 66

The dynamic dictionary management unit 66 is a cache server containing many language model sets, where each set comprises a language model and an acoustic model. A language model set is assigned to each node.

The dynamic dictionary management unit 66 serves to optimize accumulated dictionary size and improve accuracy. It loads one or more language models sets dynamically in response to the node or combination of nodes to be processed. It uses current status information such as current node, user request and level in logical hierarchy to intelligently predict the most appropriate set of language models.

Dynamic dictionary management unit 66 is linked to the service management unit 38, which supplies it with current status information for all users. FIG. 5B shows the flow of data among the natural language processing server 68, conceptual knowledge database unit 64 and the dynamic dictionary management unit 66:

1. The dynamic dictionary management unit 66 intelligently selects dictionary sets, and dispatches them to the automatic speech recognition server 60 (as shown at 130).

2. The automatic speech recognition server 60 decodes utterances and delivers words to the natural language processing server (as shown at 132).

3. The natural language processing server 68 directs raw data to the conceptual knowledge database. It derives conceptual relationships among words, thereby reducing speech recognition errors (as shown at 134).

4. The natural language processing server 68 decomposes the natural language input into linguistic structures 138 and submits the resulting structures to the conceptual knowledge database 64 (as shown at 136).

5. The conceptual knowledge database 64 enhances understanding of the structure by assigning a conceptual relationship to it (as shown at 140).

6. The resultant structure is managed by the automatic speech recognition server 60, which sends it to the service management unit (as shown at 142).

Speech Enhancement Learning Unit 70

The speech enhancement learning unit is a heuristic unit 70 that continuously enhances the recognition power of the automatic speech recognition servers 60. It is a database containing words decomposed into syllabic relationship structures, noise data, popular word usage and error cases.

The syllabic relationship structure allows the system to adapt to new pronunciations and accents. A predefined large-vocabulary dictionary gives standard pronunciations and rules. The speech enhancement learning unit 70 provides additional pronunciations and rules, thereby enhancing performance continuously over time.

Continuous improvement is further facilitated by the use of tri-phone acoustic models in the speech recognition engine. Phone substitution rules are developed from substitution inputs and used to train a neural network which, in turn, improves the processing of phone sequences. Use of the neural network is described in applicant's United States patent application entitled “Computer-Implemented Dynamic Pronunciation Method And System” (identified by applicant's identifier 225133-600-010 and filed on May 23, 2001) which is hereby incorporated by reference (including any and all drawings).

Human noise, background noise and natural pauses are used by the automatic speech recognition servers 60 to help eliminate unwanted utterances from the recognition process. These data are stored in the speech enhancement learning unit 70 database. The noise composition engine dynamically predicts and allocates these sounds, assembles them in patterns for use by the automatic speech recognition server 60, and is described in applicant's United States patent application entitled “Computer-Implemented Progressive Noise Scanning Method And System” (identified by applicant's identifier 225133-600-013 and filed on May 23, 2001) which is hereby incorporated by reference (including any and all drawings).

### Tier 2: Service Management Unit 38

The service management unit 38 represents Tier 2. The service management unit 38 provides service allocation functions. It provides conversation models for managing human-to-computer interactions. Meaningful messages derived from those interactions drive system actions including feedback to the user. It also provides development tools supplied for customizing user interaction.

Service Allocation Control Unit 150

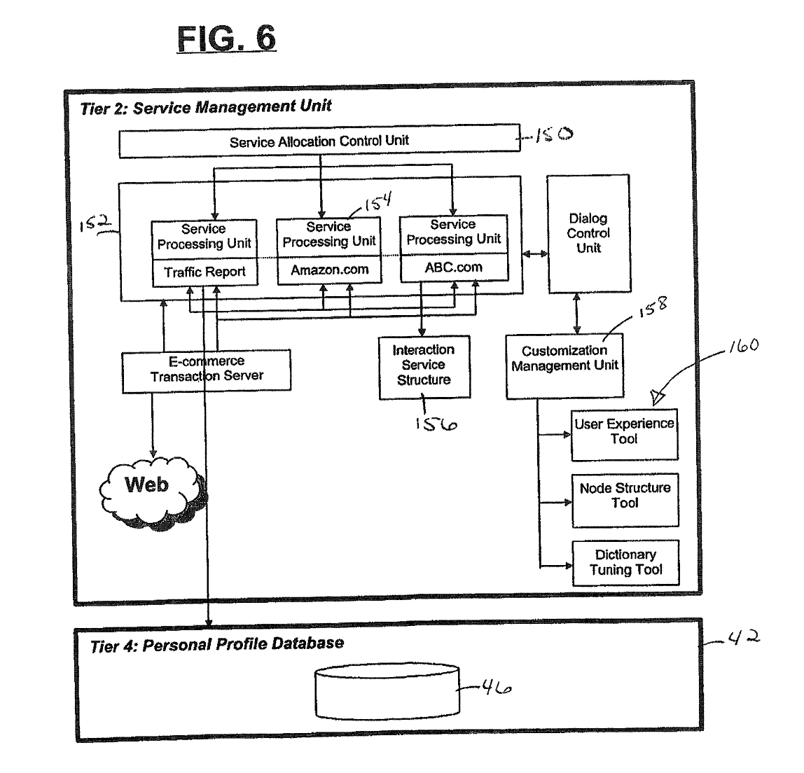

With reference to FIGS. 1 and 6, the service management unit 38 includes a service allocation control unit 150 that is an interface between Tier 1 36 and the service programs of Tier 2 38. It initiates required services on demand in response to information received from the automatic speech recognition server 60.

The service allocation control unit 150 tracks the state within each service, for example it knows when a user is in the purchase state of the Amazon service. It uses this information to determine when simultaneous access is required and launches multiple instances of the required service.

By keeping track of the current state, service allocation control unit 150 continuously sends state information to Tier l's dynamic dictionary management unit 66, where the information is used to determine the most appropriate language model sets.

Service Processing Unit 152

With reference to FIG. 6, the service processing unit 152 includes one or more instances of a particular service, for example, Amazon shopping as shown at 154. It includes a predefined data-flow layout, representing a node structure from, say, a search or an e-commerce transaction. A node also represents a specific state of user experience.

The service processing unit 152 supports the natural language ideal of accessing any information from any node. It interacts tightly with the service allocation control unit 150 and Tier 1 and from a users' request (for example, what is the weather in Toronto today?), it identifies the relevant node within the node layout structure (Toronto node within the weather node). This is described in applicant's United States patent application entitled “Computer-Implemented Intelligent Dialogue Control Method And System” (identified by applicant's identifier 225133-600-021 and filed on May 23, 2001) which is hereby incorporated by reference (including any and all drawings).

The service processing unit 152 also ensures the appropriate mapping of language models sets. The requirements are: a node can trigger one or more language models and a language model may in turn correspond to several nodes. Proper language model selection is maintained by providing current node and state information to Tier 1's dynamic dictionary management unit 66.

The service processing unit 152 also includes an interaction service structure 156, which defines the user experience at each node, including any conditional responses that may be required.

The interactive service structure is integrated with the customization interface management unit 158, which provides tools 160 for developers to shape the user experience. Tools 160 of the customization interface management tool 158 for customizing web-based dialogues include: a user experience tool for defining the dialogue between system and user; a node structure tool for defining the content to be delivered at any given node; and a dictionary tuning tool for defining key phrases that instruct the system to perform specific actions.

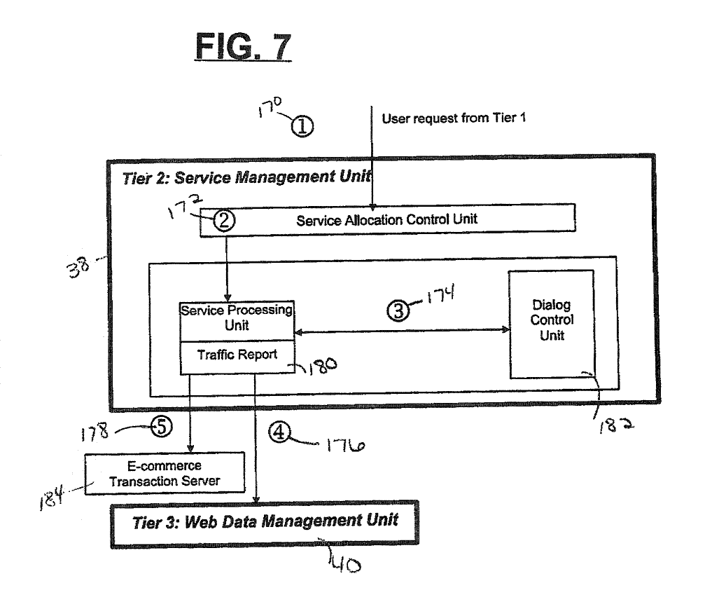

FIG. 7 provides an expanded view of the data flows and functionality of the service processing unit 152. With reference to FIG. 7:

1. The service allocation control unit 150 accepts decoded requests from Tier 1, and selects the appropriate service (e.g. traffic reports 180) from the service group (as shown at 170).

2. The service allocation control unit 150 communicates directly to the service processing unit 152 and initiates an instance of the service (as shown at 172).

3. The service processing unit 152 immediately connects to a dialogue control unit 182, from which a series of interactive responses are directed to the user (as shown at 174).

4. The service processing unit 152 fetches content information from Tier 3 (Web Data Management Unit) and dispatches it to the user (as shown at 176).

5. For e-commerce transactions, the service processing unit 152 sends a purchase request to the e-commerce transaction server 184 (as shown at 178).

E-Commerce Transaction Server 184

The e-commerce transaction server 184 provides secure 128-bit encrypted transactions through SSL and other industry standard encryption algorithms. All system databases that require high security and/or security-key access use this layer.

Users enter wallet details via a PC web portal. This information is then made available to the e-commerce transaction server 184 such that when the user requests a purchase transaction, the system requests a password via phone and perform necessary validation procedures. Specifications and format requirements for a users personal wallet are managed in the customization interface management unit 158.

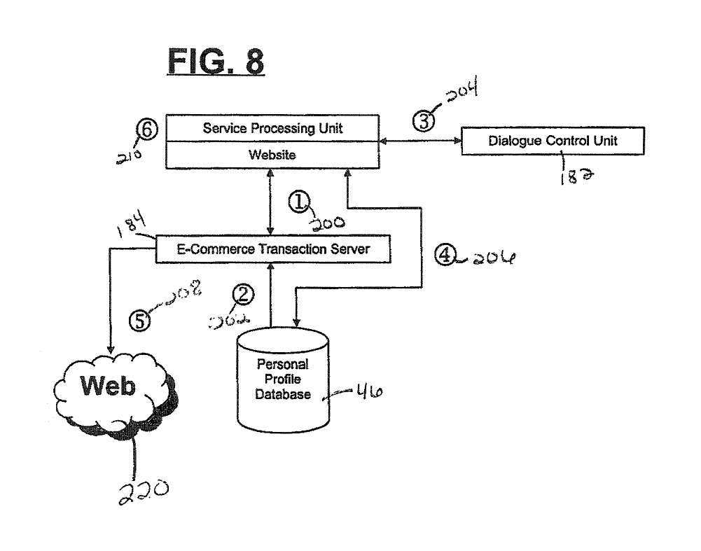

FIG. 8 shows exemplary processing of an e-commerce transaction:

1. When a user asks to check out, the e-commerce transaction server 184 responds to the request (as shown at 200).

2. The e-commerce transaction server 184 loads the user's wallet including ID, authentication and credit card information (as shown at 202).

3. The dialogue control unit asks the user to confirm the purchase with a password (or voice authentication) (as shown at 204).

4. The service processing unit logs into the personal profile database to validate the purchase (as shown at 206).

5. The e-commerce transaction server 184 initiates a real-time transaction with the specified web site, sending wallet data through a secure channel (as shown at 208).

6. The web site completes the transaction request, providing confirmation to the e-commerce transaction server 184 (as shown at 210).

Dialogue Control Unit 182

The dialogue control unit 182 manages communications between the speech management unit 36 and the service management unit 38. It tracks the dialogue between a user and a service-providing process. It uses data-structures developed in the customization management unit 158 plus linguistic rules to determine the action required in response to an utterance.

The dialogue control unit 182 maintains a dynamic dialogue framework for managing each dialogue session. It creates a data structure to represent objects—for example, a name, a product or an event—called by either the user or by the system. The structure resolves any ambiguities concerning anaphoric or cataphoric references in later interactions. The dynamic control unit is described in applicant's United States patent application entitled “Computer-Implemented Intelligent Dialogue Control Method And System” (identified by applicant's identifier 225133-600-021 and filed on May 23, 2001) which is hereby incorporated by reference (including any and all drawings).

Customization Management Unit 158

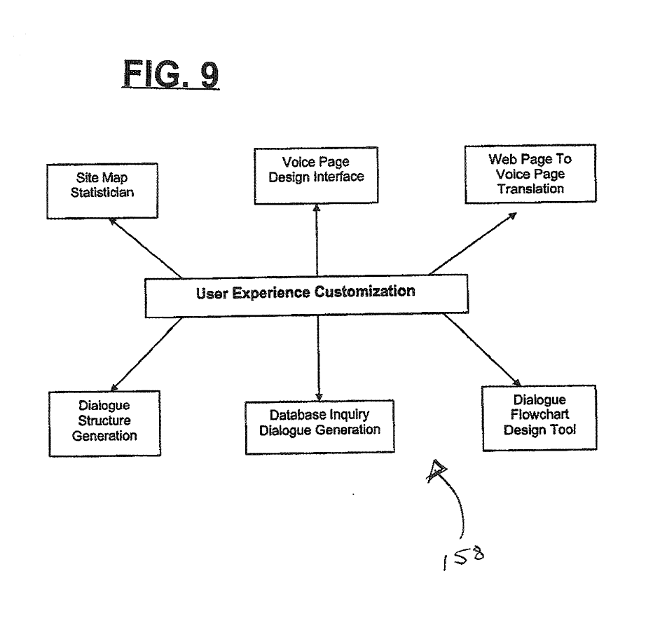

The customization management unit 158 is for developers to define the experience that the system gathers from the end user. More specifically it leads to flexible, positive voice-browsing experience irrespective of whether the source information comes from web pages, inventory databases or a promotional plan. As an example of the customization management unit 158, the software modules for user experience tool are shown in FIG. 9.

### Tier 3: Web Data Management Unit 40

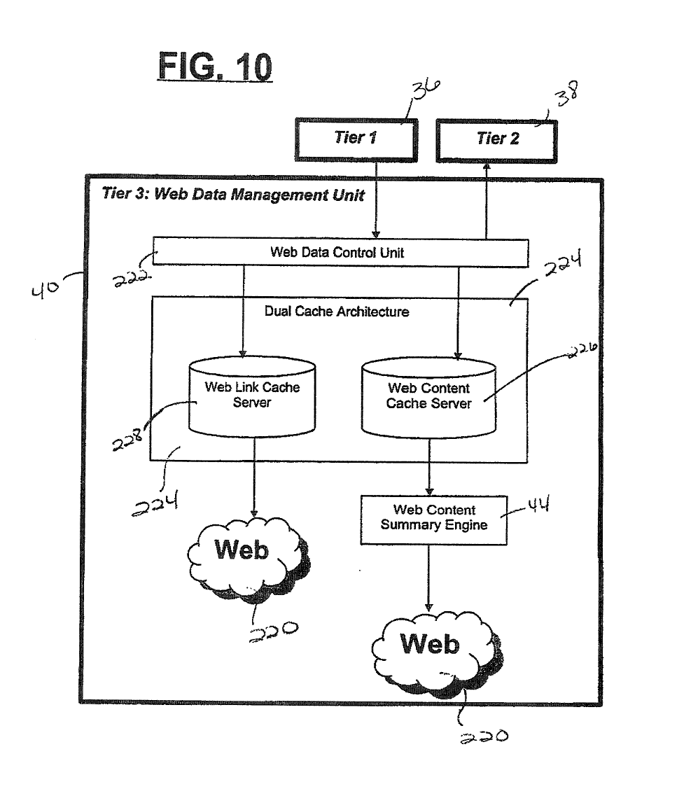

With reference to FIG. 10, the web data management unit 40 summarizes the content of web sites 220 for wireless access and voice presentation with little or no human intervention. It is a knowledge discovery unit that retrieves relevant information from web sites 220 and presents it as audio output in such a way as to provide a meaningful audio experience for the user.

Web Data Control Unit 222

The web data control unit 222 connects directly to Tier 1 36 and Tier 2 38. When a web page is processed for wireless access, its structure is sent dynamically to the service management unit 38 for formatting and summarization in accordance with the rules contained in the customization management unit 158. Modifications to the web site structures are then cached on the web content cache server 224, with the web data control unit 222 controlling the interaction.

The web data control unit 222 dispatches the dictionary structure of a site to Tier 1 36, and in particular, to the dynamic dictionary management unit 66. It also manages the interaction between the dynamic dictionary management unit 66 (where words are recognized) and the web content cache server 224 (where web content data resides).

A parallel-CPU, multi-threaded architecture ensures optimal performance. Multiple instances are stored in web content cache unit 224. Where simultaneous access to a particular site is required, the system queues the input requests and prioritizes access.

Web Content Cache Unit 224

The web content cache unit 224 utilizes a dual architecture: a web content cache server 226 that stores the content of selected web sites, and a web link cache server 228 that stores the structure of those web sites including a node structure with web-links at each node.

To minimize response times, web content cache unit 224 treats popular web sites differently from other less popular sites. Popular sites are stored in the web content cache server 226. Less frequently accessed sites are retrieved on demand.

When the web content cache unit 224 requests a web site from the web link cache server 228 that is not in cache, the web link cache server 228 identifies the relevant note and dispatches a link to the Internet. The web content summary engine 44 processes the request and returns the required information to the web data control unit 222.

This architecture allows the web data management unit 40 to process a large number of web sites 220 with minimal delay. Typical response times are less than 0.5 seconds to return a page from cache and less than 1 second to download (with dedicated Internet relay) a non-cached page.

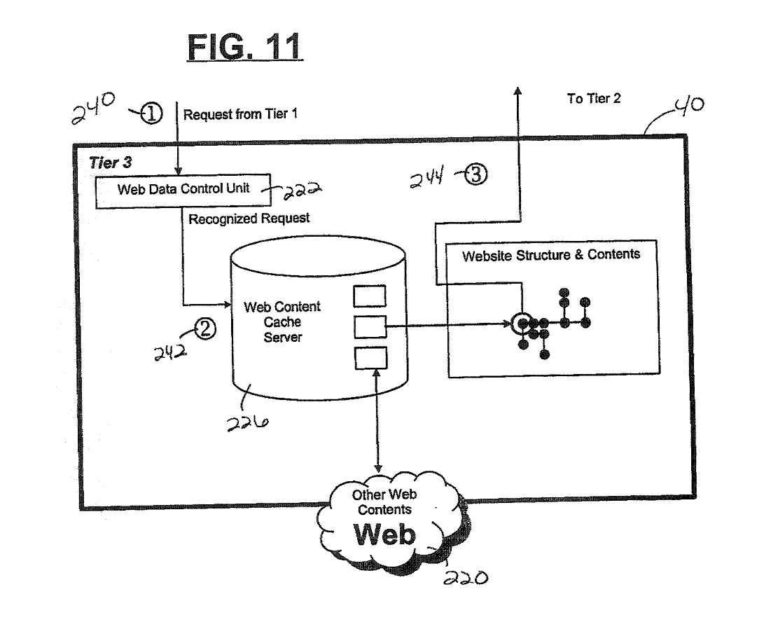

FIG. 11 describes the operation of the web content cache server 226:

1. Upon the speech management unit 36 recognizing a request from a user, the web data control unit 222 issues an instruction to retrieve contents from Tier 3 (as shown at 240).

2. Web data control unit 222 checks whether the content is immediately available in the web content cache server (as shown at 242).

3. The appropriate content is then returned and dispatched to Tier 2 (as shown at 244).

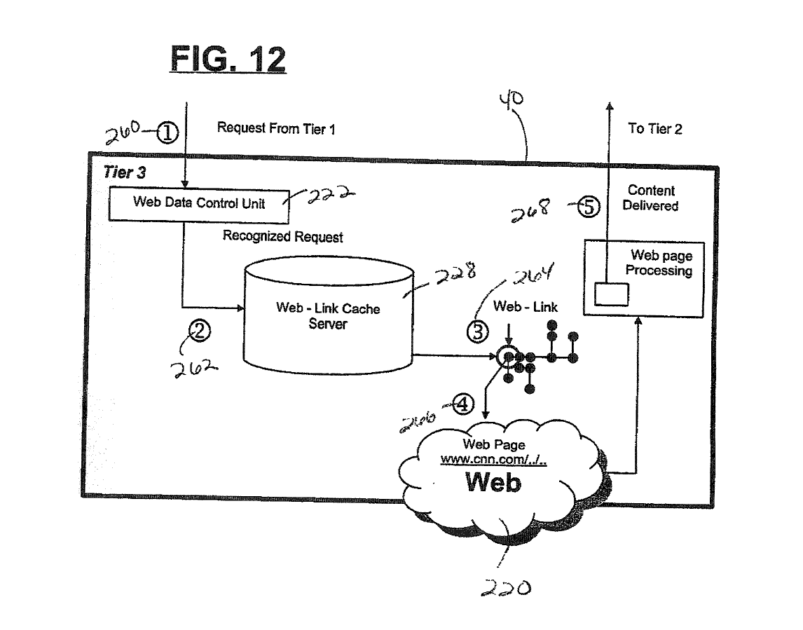

FIG. 12 shows the operation of the web link cache server:

1. Upon the speech management unit 36 recognizing a request from a user, the web data control unit 222 issues an instruction to retrieve contents from Tier 3 (as shown at 260).

2. If the web data control unit 222 determines that the required content is not in the web content cache server 226, it issues a request to web link cache server 228 (as shown at 262).

3. The link associated with the node contains the address for the required web page (as shown at 264).

4. The web link cache server 228 caches the required web page while its contents are sent for further processing (as shown at 266).

5. The content is routed to Tier 2 for processing (as shown at 268).

Web Content Summary Engine 44

The web content summary engine 44 summarizes information from a particular web site and reorganizes it so as to make its content relevant and understandable to users on a telephone. Since users cannot view a site when voice browsing, the web content summary engine 44 acts as an “audio mirror” through which the user can interactively browse by listening and speaking on a phone.

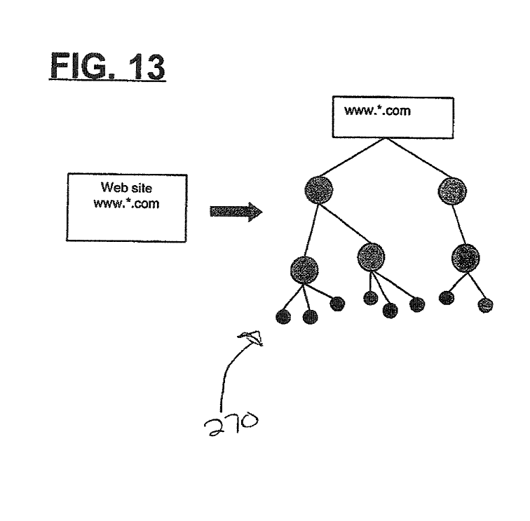

Web content summary engine 44 sends knowledge discovery engine to requested web sites. The web content summary engine 44 then interprets the data returned by these engines, decomposing web pages and reconstructing the topology of each site. Using structure and relative link information it filters out irrelevant and undesirable information including figures, ads, graphics, Flash and Java scripts. The resulting “web summaries” are returned to the web content cache unit 224 where the content of each page is categorized, classified and itemized. The end result is a web site information tree as shown at 270 in FIG. 13 where a node represents a web page and a connection between two nodes represents a hyperlink between the web pages.

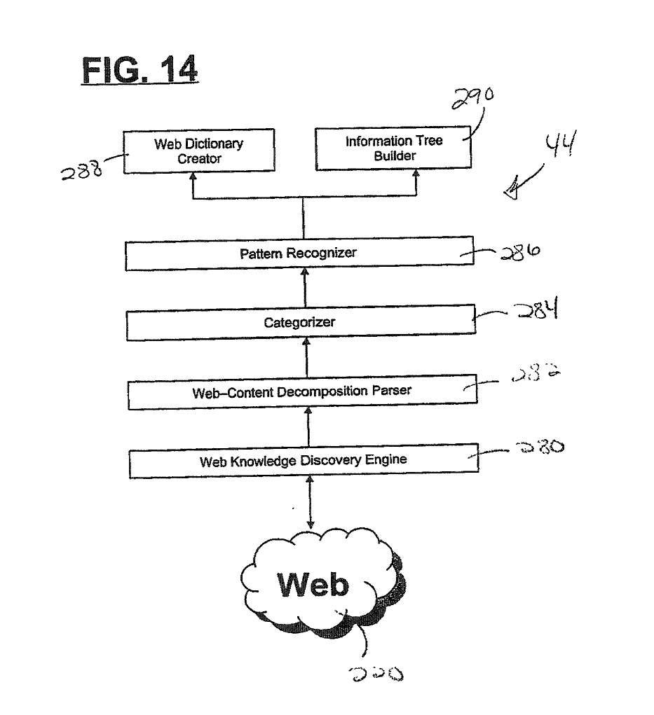

With reference to FIG. 14, the web content summary engine 44 uses the following modules—knowledge structure discovery engine 280 is used wherein a spider crawls through specified web sites 220 and creates frame-node representations of those sites. Web content decomposition parser 282 is used wherein an engine creates a simplified regular form of HTML from the raw data returned by the discovery engine 280. It recognizes XML code and the different forms of HTML, and organizes the resulting data into object blocks and sections. To ensure the output is robust, it recognizes imperfect web pages, eliminating un-nested tags and missing end-tags. The resulting structure is ready for pattern recognition. Categorizer is used wherein it categorizes text objects into distinct categories including large text blocks, small text blocks, link headers, category headers, site navigation bars, possible headers and irrelevant data. Starting and ending list tags, as well as strong break tags are passed through as tokens; links are assembled into a list. Pattern Recognizer 286 is used to process data streams from the categorizer 284. Using pattern recognition algorithms, it identifies relevant sections (categories, main sections, specials, links), and groups them into patterns that that define ways to present web content by voice over telephone. The parser 282, categorizer 284, and pattern recognizer are described in applicant's United States patent application entitled “Computer-Implemented Html Pattern Parsing Method And System” (identified by applicant's identifier 225133-600-018 and filed on May 23, 2001) which is hereby incorporated by reference (including any and all drawings). A web dictionary creator 228 is used to create language models or dictionaries that correspond to the HTML or XML contents identified by the pattern recognizer 286. By allocating important words and phrases, it ensures that language models are relevant to a given domain. An information tree builder 290 is used to build tree-node structures for voice access. It reconstructs the topology of a web site by building a tree with nodes and leaves, attaching proper titles to nodes and mapping texts to leaves. It also adds navigation directions to each node so that the user can browse, get lists and search for key words and phrases.

### Tier 4: Database and Personal Profiles 42

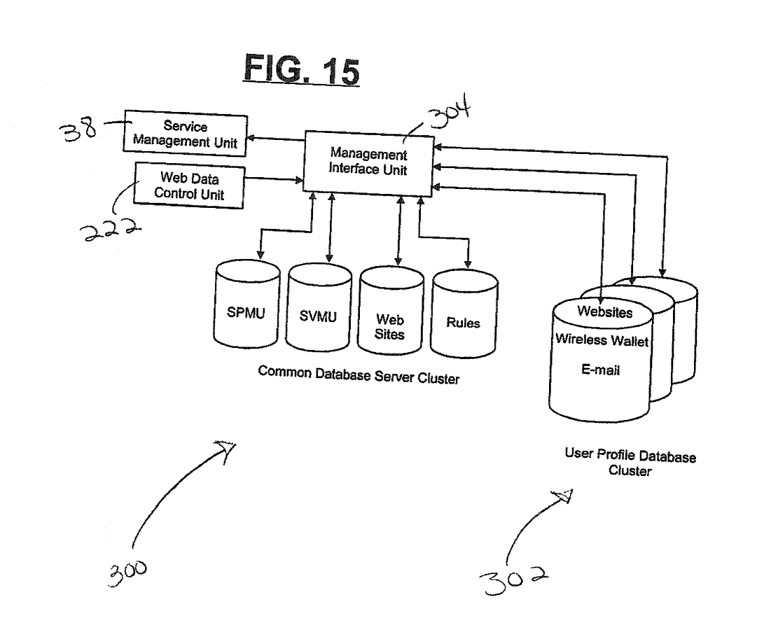

Tier 4 42 provides supporting database servers for the voice portal system 30. As shown in FIG. 15, it includes: a cluster database servers 300 that provide common data storage; and a cluster of secure databases that contain user profile information. A management interface unit 304 is responsible for communications between the service management unit 38, the web data control unit 222 and other databases.

Management Interface Unit 304

The management interface unit 304 provides a common gate for coordinating access and updating of all databases. In effect it is a “super database” that maximizes the performance of all databases by providing the following functions: security check; data integrity check; data format uniformity check; resource allocation; data sharing; and statistical monitoring.

The Common Database Server Cluster 300 stores information that is accessible to authorized users.

The User Profile Database Cluster 302 contains user-specific information. It includes information such as the users “wallet”, favorite web sites and favorite voice pages.

### System Security

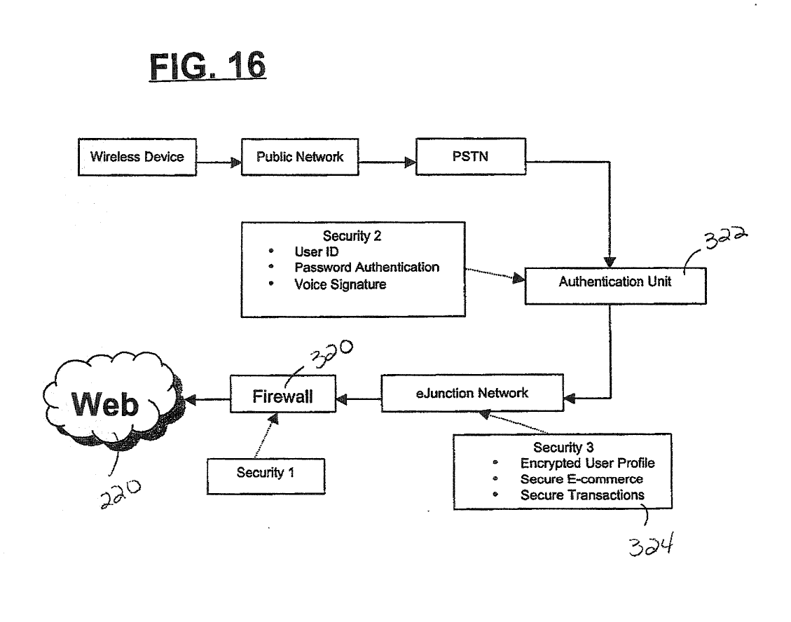

The voice portal system 30 is fully secure. Three security provisions ensure it is fully protected from unwanted intrusions and disruptions. FIG. 16 illustrates these provisions.

Security 1: Firewall

A firewall 320 separates the voice portal system 30 from the public Internet 220. All information passing between the two passes through the firewall 320. By filtering, monitoring and logging all sessions between these two networks, the firewall 320 serves to protect the internal network from external attack.

Security 2: User Authentication with User ID and Password

During the login process, the system authenticates user at block 232 by requesting a user ID and password. The user ID is, by default, the user's ten-digit telephone number. The system also invites the user to choose a four to eight digit Personal Information Number (PIN). This information is stored in the secure personal profile database management unit. Users have the option of enabling voice signature as an authentication option. This permits login by voice, either with or without cross verification by ID and PIN. Training is required to enable the Voice Signature option. The user must invest a few minutes at a PC to provide a clear registration of his/her voice signature. After recording a series of words, the system determines the attributes of the user's speech and stores a voice signature in a secure database.

Security 3: Secure E—commerce Transactions

As shown at block 324, user profiles and “wallet” information such as credit card details are encrypted and stored in a secure database as discussed above. When transactions are initiated, these data are processed in a secure way using 128-bit encrypted SSL/TLS.

### Network Implementation

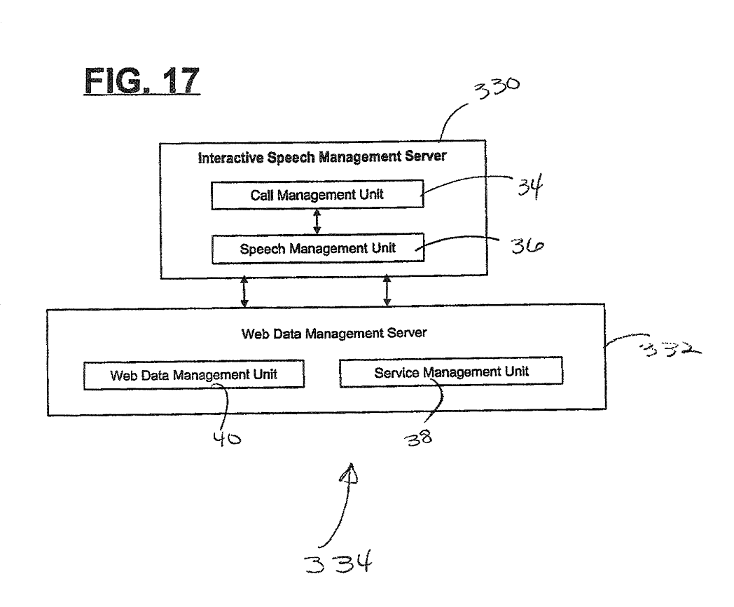

With reference to FIG. 17, voice traffic is delivered to the system by TI connections. Each TI line provides 24 simultaneous voice channels. The call management unit 34 manages the traffic.

High call volume may require multiple call management units 34. Each call management unit 34 communicates with “N” automatic speech recognition servers in the speech management unit 36, where: N is a number determined by the required quality of service, and quality of service is the response time of the system.

As N increases, response time decreases. An optimal choice may be N=6 or six servers per T1 line.

To guarantee high speed and reliability, an interactive speech management server 330 is implemented on an industrial-grade, high-reliability, rack-mounted CompactNET multiprocessor system from Ziatech Corporation. Taken together, one call management unit 34 and N automatic speech recognition servers form an interactive speech management server 330. A web data management server 332 may hold both the web data management unit 40 and the service management unit 38.

The system architecture 334 is modular and can be expanded easily when required. The unit of the expansion can be as low as one ISMU-T1 or as high as several ISMU-T4's.

It can be scaled to handle any number of simultaneous callers. One web data management server 332 can handle twenty interactive speech management server 330 units. This follows from the fact that one web data management server 332 can handle 500 simultaneous hits within a reasonable response time, while each interactive speech management server 330 is limited to the 24 channel capacity of a T1 line.

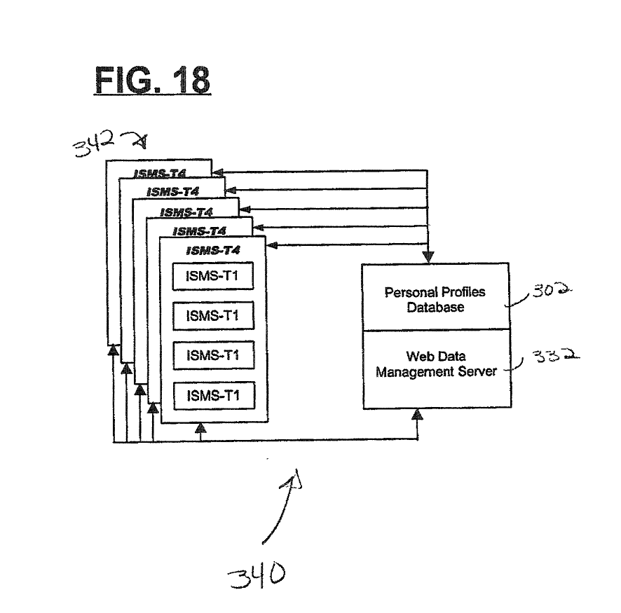

FIG. 18, shows a system configuration 340 that can handle 480 simultaneous users. It comprises five Quadruple ISRS 342 each capable of handling 96 simultaneous users. Each ISMU-T4 consists of four ISMU-T1's as shown.

Service Provider Solution

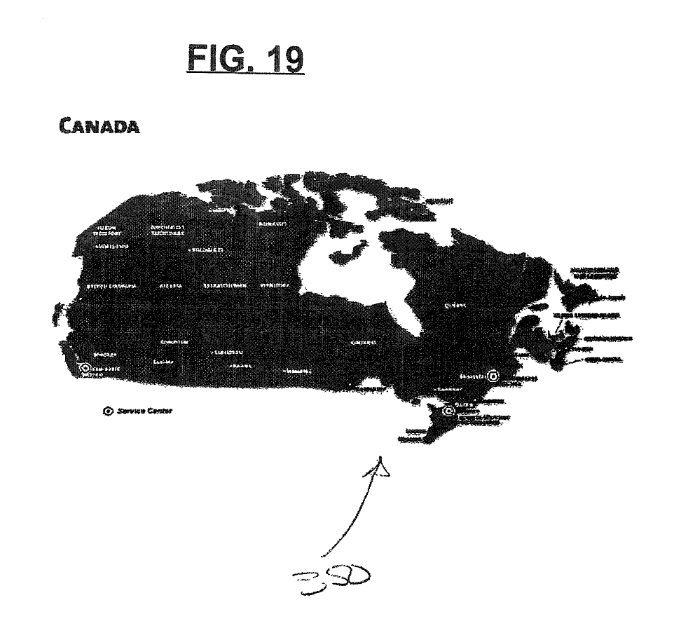

Implementing a solution for a service provider may require a set of service centers similar to what is depicted on FIG. 19. While service centers may be distributed, the personal profile database, a secure server, is best centralized because updating is more effective and efficient; and security is improved.

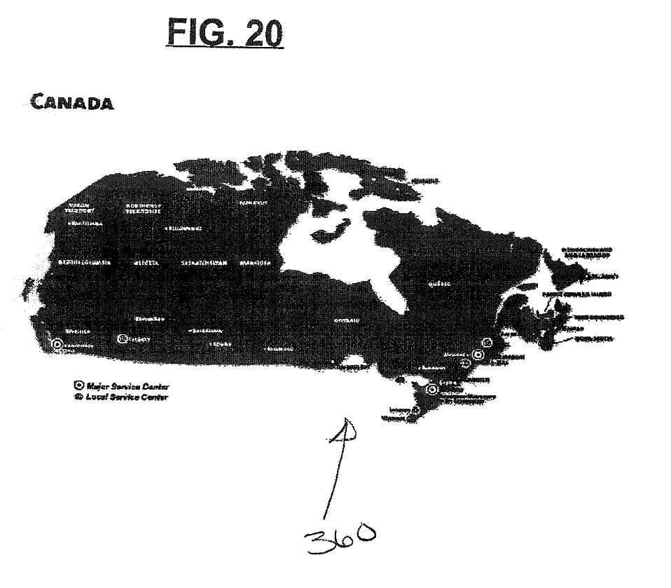

The actual network configuration ultimately depends on the communication network of the client and the network policies involved. FIGS. 19 and 20 show two example solutions for a wireless network in Canada.

FIG. 19 is a wide area service center model as shown at 350. Each service center serves one population cluster within the network, specifically Vancouver, Montreal and Toronto. Voice traffic from the surrounding areas of these cities is directed to the local centers. While this solution is likely to incur significant long distance or 1-800 charges, these are offset by lower implementation and network administration costs.

FIG. 20 depicts another example wherein a local area service center model is shown at 360. It proposes a number of local area service centers so as to avoid the cost of long distance or 1-800 calling, though implementation and network administration costs are likely to be higher than for a wide area solution. Local centers comprise a number of ISMU-T4's, the actual number depending on the required calling capacity.

The preferred embodiment described within this document is presented only to demonstrate an example of the invention. Additional and/or alternative embodiments of the invention will be apparent to one of ordinary skill in the art upon reading this disclosure.

It is claimed:

1. A computer-implemented system for processing speech input from a user, comprising:
a call management unit that receives a call from the user and through which the user speech input is provided;
a speech management unit connected to the call management unit to recognize the user speech input through language recognition models, said language recognition models containing word recognition probability data derived from word usage on Internet web pages;
a service management unit connected to the speech management unit to handle a electronic-commerce request contained in the user speech input; and
a web data management unit connected to an Internet network that processes Internet web pages in order to generate the language recognition models for the speech management unit and to generate a summary of the Internet web pages, wherein said generated summary is voiced to the user in order to service the user request.
